(19) United States
(12) Patent Application Publication
(10) Pub. No.: US 2020/0313433 A1
(43) Pub. Date: Oct. 1, 2020

(54) DATA-DRIVEN THREE-STAGE SCHEDULING METHOD FOR ELECTRICITY, HEAT AND GAS NETWORKS BASED ON WIND ELECTRICITY INDETERMINACY

(71) Applicant: NANJING INSTITUTE OF TECHNOLOGY, Jiangsu (CN)

(72) Inventors: Guangyu CHEN, Jiangsu (CN); Yangfei ZHANG, Jiangsu (CN); Sipeng HAO, Jiangsu (CN); Haitao LIU, Jiangsu (CN)

(73) Assignee: NANJING INSTITUTE OF TECHNOLOGY, Jiangsu (CN)

(21) Appl. No.: 16/760,446

(22) PCT Filed: Feb. 28, 2019
(86) PCT No.: PCT/CN2019/076426

§ 371 Date: Apr. 30, 2020

(30) Foreign Application Priority Data
Jun. 6, 2018 (CN) 201810586897.9

(51) Int. Cl. H02J 3/00; H02J 3/38; G06Q 50/06; G06F 17/12; G06F 17/16

(52) U.S. Cl. CPC H02J 3/008; H02J 3/001; G06F 17/16; G06Q 50/06; G06F 17/12; H02J 3/381

(57) ABSTRACT

The present invention discloses a data-driven three-stage scheduling method for electricity, heat and gas networks based on wind electricity indeterminacy, including the following steps: S1, initializing; S2, establishing a deterministic electricity-heat-gas coordination optimized scheduling model; S3, establishing a data-driven distributed robust scheduling optimization model under mixed norms; S4, solving a master economic scheduling problem; S5, verifying convergence of a wind electricity indeterminacy subproblem: if the subproblem converges, going to step S6, otherwise going to step S4 and adding a constraint to the master economic scheduling problem by using a CCG algorithm; and S6, checking the convergence of a gas network operation constraint subproblem: if the gas network operation constraint subproblem converges, ending the calculation to obtain an optimal solution, otherwise, going to step S4 and adding a Benders cut set constraint to the master economic scheduling problem.

### BACKGROUND

### Technical Field

The present invention relates to a data-driven three-stage scheduling method for electricity, heat and gas networks based on wind electricity indeterminacy, and belongs to electric power systems and control technologies thereof.

### Description of Related Art

At present, wind abandoning and electricity brownout is still a main factor restricting the development of wind electricity, and there is high indeterminacy in the wind electricity. Moreover, conventional stochastic programming and robust optimization methods have problems such as one-sidedness, conservativeness, and economics to different degrees. Due to the independence of the electricity, heat and gas systems, it is typical to program and operate them independently, leading to absence of mutual coordination and failure in efficient utilization of energy.

However, in recent years, more and more researches in China and abroad have been conducted on electricity, heat and gas networks, which thus have become more and more associated and are mutually affected and restricted. Therefore, the constant coupling among the electricity, heat and gas systems has brought infinite possibilities to further improve wind electricity consumption and energy utilization and has also laid a foundation for the researches on the coordination and optimization of electricity, heat and gas systems.

### SUMMARY

Object of Invention: to overcome the shortcomings in the prior art, the present invention provides a data-driven three-stage scheduling method for electricity, heat and gas networks based on wind electricity indeterminacy, which, under the operation constraints of an electricity network, a heat network and a gas network, can reasonably arrange the outputs of respective units and effectively utilize an energy storage device to respond to the indeterminacy of wind electricity, thereby improving the economics of system operation.

Technical Solution: To achieve the object above, the technical solutions of the present invention are as follows.

A data-driven three-stage scheduling method for electricity, heat and gas networks based on wind electricity indeterminacy includes the following steps:

S1, acquire calculation data and initialize variables and the calculation data.

S2, establish a deterministic electricity-heat-gas coordination optimized scheduling model.

S21, establish an objective function of an integrated system.

The electricity-heat-gas coordination optimized scheduling model provided by the present invention is intended to, under the operation constraints of an electricity network, a heat network and a gas network, reasonably arrange the outputs of respective units and effectively utilize an energy storage device to respond to the indeterminacy of wind electricity; and the present invention has a scheduling object of minimizing the operating cost of an integrated electricity-heat-gas system:

min(F₁+F₂+F₃+F₄+F₅) (1)

wherein F₁ is an electricity generation cost function of the regular units; F₂ is an electricity generation cost function of the combined heat and electricity units; F₃ is an electricity generation cost function of the gas units; F₄ is wind electricity abandoning penalty cost; and F₅ is load-shedding penalty cost.

(1) Electricity Generation Cost of Regular Units:

The electricity generation cost of the regular units includes startup and shutdown cost and operating cost:

$$\begin{matrix}{F}_{1} = {F}_{11} + {F}_{12} & ( 2 ) \\ {F}_{11} = {\sum }_{t = 1}^{T} {\sum }_{i = 1}^{{N}_{G}} [ {K}_{Ri} {μ}_{i , t} ( 1 - {μ}_{i , t - 1} ) + {K}_{Si} {μ}_{i , t - 1} ( 1 - {μ}_{i , t} ) ] & ( 3 ) \\ {F}_{12} = {\sum }_{t = 1}^{T} {\sum }_{i = 1}^{{N}_{G}} ( {a}_{i} {P}_{i , t}^{2} + {b}_{i} {P}_{i , t} + {c}_{i} {μ}_{i , t} ) & ( 4 )\end{matrix}$$

wherein F₁₁ represents the startup and shutdown cost; F₁₂ represents the operating cost; T represents the total number of periods; N_{G} represents the number of the regular units; K_{Ri} and K_{Si} represent startup and shutdown cost of the i^{th} regular unit respectively; Boolean variables μ_{i,t} and μ_{i,t-1} represent the startup and shutdown flags, with 1 indicating a startup state and 0 indicating a shutdown state; aᵢ, bᵢ, cᵢ represent coefficients of secondary electricity generation cost functions of the i^{th} electricity generation unit; and P_{i,t} represents the active output of the i^{th} regular unit during the period t.

(2) Cost of Combined Heat and Electricity Units

The combined heat and electricity units involved in the present invention have always been in a normally open state, so there is no startup and shutdown, and thus, the operating cost is considered only.

$${F}_{2} = {\sum }_{t = 1}^{T} {\sum }_{i = 1}^{{N}_{C}} \{ {{a}_{i}^{c h p} ( {P}_{i , t}^{c h p} )}^{2} + {b}_{i}^{chp} {P}_{i , t}^{c h p} + {c}_{i}^{c h p} + {{d}_{i}^{c h p} ( {Q}_{i , t}^{c h p} )}^{2} + {e}_{i}^{chp} {Q}_{i , t}^{c h p} + {f}_{i}^{c h p} {Q}_{i , t}^{c h p} {P}_{i , t}^{c h p} \} \qquad ( 5 )$$

Wherein N_{C} represents the number of combined heat and electricity units; aᵢ^{chp}, bᵢ^{chp}, cᵢ^{chp}, dᵢ^{chp}, eᵢ^{chp}, fᵢ^{chp} represent coefficients of the equivalent electricity generation cost of the i^{th} combined heat and electricity unit; P_{i,t}^{chp} and Q_{i,t}^{chp} represent the electric power output and the heat power output of the i^{th} combined heat and electricity unit during the period t.

(3) Cost of Gas Units

$${F}_{3} = {\sum }_{t = 1}^{T} {\sum }_{i = 1}^{{N}_{g}} g ( {P}_{i , t}^{gas} ) \qquad ( 6 )$$

wherein N_{g} represents the number of gas units; g represents an operating cost function of the gas units; and p_{i,t}^{gas} represents an active output of the i^{th} gas unit during the period t.

(4) Wind Abandoning Cost

$${F}_{4} = {\sum }_{t = 1}^{T} {\sum }_{i = 1}^{{N}_{w}} {λ}_{w} ( {P}_{i , t}^{w e} - {P}_{i , t}^{w} ) \qquad ( 7 )$$

wherein N_{w} represents the number of wind turbine units; λ_{w} represents a wind abandoning penalty coefficient; and P_{i,t}^{we} and P_{i,t}^{w} represent a predicted output and an actual scheduled output of the i^{th} wind turbine at the time t, respectively.

(5) Load-Shedding Cost

$${F}_{5} = {\sum }_{t = 1}^{T} {λ}_{N} {P}_{t}^{N} \qquad ( 8 )$$

wherein λ_{N} represents a load-shedding penalty coefficient; and Pₜ^{N} represents a load-shedding amount at the time t.

S22, establish equality and inequality constraints of the integrated system.

The integrated system constraints include electricity network constraints, heat network constraints, gas network constraints, and coupling element constraints.

(1) Electricity Network Constraints

\textcircled{1} Constraints of Electric Power Balance:

$${\sum }_{i = 1}^{{N}_{G}} {P}_{i , t} + {\sum }_{i = 1}^{{N}_{c}} {P}_{i , t}^{c h p} + {\sum }_{i = 1}^{{N}_{w}} {P}_{i , t}^{w} + {\sum }_{i = 1}^{{N}_{g}} {P}_{i , t}^{g a s} + {\sum }_{i = 1}^{{N}_{E S}} {P}_{i , t}^{E S} + \sum {P}_{t}^{N} = \sum {P}_{t}^{D} + {\sum }_{i = 1}^{{N}_{EB}} {P}_{i , t}^{E B} \qquad ( 9 )$$

wherein N_{ES} represents the number of electricity storage devices; P_{i,t}^{ES} is the charge and discharge power of the i^{th} electricity storage device at the time t, P_{i,t}^{ES}>0 represents discharging of the electricity storage devices, and P_{i,t}^{ES}<0 represents charging of the electricity storage devices; ΣPₜ^{D} is the total electrical load power of the system during the period t; N_{EB} represents the number of the electric boilers; and P_{i,t}^{EB} represents the active power consumed by the i^{th} electric boiler at the time t.

\textcircled{2} Constraints of Output Limits for Regular Units, Combined Heat and Electricity Units and Gas Units:

μ_{i,t}P_{i,min}≤P_{i,t}≤μ_{i,t}P_{i,max} (10)

P_{i,min}^{chp}≤P_{i,t}^{chp}≤P_{i,max}^{chp} (11)

P_{i,min}^{gas}≤P_{i,t}^{gas}≤P_{i,max}^{gas} (12)

wherein P_{i,min} and P_{i,max} are lower and upper limits of the output of the i^{th} regular unit respectively; P_{i,min}^{chp} and P_{i,max}^{chp} are lower and upper limits of the output of the i^{th} combined heat and electricity unit respectively; and P_{i,min}^{gas} and P_{i,max}^{gas} are lower and upper limits of the output of the i^{th} gas unit, respectively.

\textcircled{3} Climbing Constraints for Regular Units, Combined Heat and Electricity Units and Gas Units:

−R_{Di}Tₛ≤P_{i,t}−P_{i,t-1}≤R_{Ui}Tₛ (13)

−R_{Di}^{chp}Tₛ≤P_{i,t}^{chp}−P_{i,t-1}^{chp}≤R_{Ui}^{chp}Tₛ (14)

−R_{Di}^{gas}Tₛ≤P_{i,t}^{gas}−P_{i,t-1}^{gas}≤R_{Ui}^{gas}Tₛ (15)

wherein R_{Ui} and R_{Di} are up-climbing and down-climbing rates of the i^{th} regular unit respectively; R_{Ui}^{chp} and R_{Di}^{chp} are up-climbing and down-climbing rates of the i^{th} combined heat and electricity unit respectively; R_{Ui}^{gas} and R_{Di}^{gas} are up-climbing and down-climbing rates of the i^{th} combined heat and electricity unit respectively; and Tₛ is a scheduling period.

\textcircled{4} Constraints of Minimum Startup and Shutdown Time for Regular Units:

$$\begin{matrix}{\sum }_{h = t}^{t + {T}_{i}^{o n} - 1} {μ}_{i , h} \geq {T}_{i}^{o n} ( {μ}_{i , t} - {μ}_{i , t - 1} ) , ∀ t \leq T - {T}_{i}^{o n} + 1 & ( 16 ) \\ {\sum }_{h = t}^{t + {T}_{i}^{off} - 1} ( 1 - {μ}_{i , h} ) \geq {T}_{i}^{o f f} ( {μ}_{i , t - 1} - {μ}_{i , t} ) , ∀ t \leq T - {T}_{i}^{o f f} + 1 & ( 17 ) \\ {\sum }_{t = 1}^{{T}_{i}^{o n} - {T}_{i}^{ui}} ( 1 - {μ}_{i , t} ) = 0 & ( 18 ) \\ {\sum }_{t = 1}^{{T}_{i}^{off} - {T}_{i}^{di}} {μ}_{i , t} = 0 & ( 19 )\end{matrix}$$

wherein Tᵢ^{on} and Tᵢ^{off} represent the minimum startup and shutdown times of the i^{th} regular unit respectively; Tᵢ^{ui} and Tᵢ^{di} respectively represent initial startup and shutdown time of the i^{th} regular unit at an early stage of scheduling; equations (16) and (17) are constraint equations of the minimum startup and shutdown time of the regular units; and equations (18) and (19) are constraint equations of the initial start-up and shutdown time of the regular units.

\textcircled{5} Constraints for Electricity Storage Device:

μ_{i,t}^{c}+μ_{i,t}^{d}≤1 (20)

−P_{dc}≤P_{i,t}^{ES}=P_{i,t}^{d}−P_{i,t}^{c}≤P_{dc} (21)

η_{i,t}^{d}P_{i,min}^{d}≤P_{i,t}^{d}≤η_{i,t}^{d}P_{i,max}^{d} (22)

η_{i,t}^{c}P_{i,min}^{c}≤P_{i,t}^{c}≤η_{i,t}^{c}P_{i,max}^{c} (23)

E_{i,t+1}^{ES}=E_{i,t}^{ES}+α_{c}P_{i,t}^{c}−α_{d}P_{i,t}^{d} (24)

E_{i,min}^{ES}≤E_{i,t}^{ES}≤E_{i,max}^{ES} (25)

wherein ρ_{i,t}^{c} represents a charging state of the i^{th} electricity storage device at the time t, with η_{i,t}^{c}=1 indicating the device is in a charging state, and μ_{i,t}^{c}0 indicating the device is in a discharging or idle sate; μ_{i,t}^{d} is a discharging state of the i^{th} electricity storage device at the time t, with μ_{i,t}^{d}=1 indicating the device is in a discharging state, and μ_{i,t}^{d}=0 indicating the device is in a charging or idle state, where it is considered that the electricity storage device cannot be charged or discharged simultaneously at the same time; P_{dc} represents a maximum power variation range of the electricity storage device; P_{t,i}^{c}, P_{i,t}^{d}, and E_{i,t}^{ES} represent charging power, discharging power and electricity storage capacity of the i^{th} electricity storage device at the time t, respectively; P_{i,min}^{c} and P_{i,max}^{c} represents lower and upper limits of the charging power of the i^{th} electricity storage device at the time t respectively; P_{i,min}^{d} and P_{i,max}^{d} represents lower and upper limits of the discharging power of the i^{th} electricity storage device at the time t respectively; α_{c} and α_{d} represent charging and discharging coefficients respectively, and E_{i,min}^{ES} E_{i,max}^{ES} represent lower and upper limits of the capacity of the i^{th} electricity storage device respectively.

\textcircled{6} Constraints of Electric Power for Electric Boilers:

0≤P_{i,t}^{EB}≤P̅ᵢ^{EB} (26)

wherein P̅ᵢ^{EB} represents a rated power of the i^{th} electric boiler.

\textcircled{7} Constraints of Wind Electricity Output:

0≤P_{i,t}^{w}≤P_{i,t}^{we} (27)

\textcircled{8} Constraints of Power Flow:

In the present invention, a direct-current power flow method is used for calculation, and a branch power flow should meet:

$${P}_{line} = {B}_{d i a g} {LB}^{- 1} [ {P}_{t} + {P}_{t}^{w} + {P}_{t}^{c h p} + {P}_{t}^{g a s} + {P}_{t}^{E S} + {P}_{t}^{N} - {P}_{t}^{D} - {P}_{t}^{E S} ] - {\overline{P}}_{line} \leq {P}_{line} \leq {\overline{P}}_{line} \\ {B}_{d i a g} = diag ( \frac{1}{{x}_{1}} , … , \frac{1}{{x}_{N L}} ) \qquad ( 28 )$$

wherein B is a matrix of B coefficients; x₁ is the reactance of a branch l; NL is the total number of branches in a system; L is a connection matrix of branch nodes of the system; Pₜ, Pₜ^{w}, Pₜ^{chp}, Pₜ^{gas}, Pₜ^{ES}, Pₜ^{N}, Pₜ^{D} and Pₜ^{EB} indicate vector representations of the active power at the time t of the regular units, the wind electricity units, the combined heat and electricity units, the gas units, the electricity storage devices, the load-shedding amount, the total load and the electric boiler under the total node dimension of the system; Pₗᵢₙₑ is branch power; and P̅ₗᵢₙₑ is an upper limit of the branch power.

(2) Constraints for Heat Network

\textcircled{1} Constraints of Heat Power Balance:

$${\sum }_{i = 1}^{{N}_{C}} {Q}_{i , t}^{c h p} + {\sum }_{i = 1}^{{N}_{E B}} {Q}_{i , t}^{E B} + {\sum }_{i = 1}^{{N}_{CT}} {Q}_{i , t}^{C T} = {Q}_{t}^{D} \qquad ( 29 )$$

wherein Q_{i,t}^{EB} represents the heat supply power of the i^{th} electric boiler at the time t; N_{CT} represents the number of the heat storage devices; Q_{i,t}^{CT} represents heat storage and release power of the i^{th} heat storage device at the time t, with Q_{i,t}^{CT}>0 indicating heat storage, and Q_{i,t}^{CT}<0 indicating heat release; and Qₜ^{D} represents the total heat load power at the time t.

\textcircled{2} Constraints of Heat Power for Combined Heat and Electricity Units:

$${\sum }_{i = 1}^{{N}_{C}} {Q}_{i , t}^{c h p} + {\sum }_{i = 1}^{{N}_{E B}} {Q}_{i , t}^{E B} + {\sum }_{i = 1}^{{N}_{CT}} {Q}_{i , t}^{C T} = {Q}_{t}^{D} \qquad ( 30 )$$

wherein Q_{i,min}^{chp} and Q_{i,max}^{chp} indicate lower and upper limits of the i^{th} combined heat and electricity unit.

\textcircled{3} Constraints for Heat Storage Devices:

ω_{i,t}^{c}+ω_{i,t}^{d}≤1 (31)

−Q_{dc}≤Q_{i,t}^{CT}=Q_{i,t}^{d}−Q_{i,t}^{c}≤Q_{dc} (32)

ω_{i,t}^{d}Q_{i,min}^{d}≤Q_{i,t}^{d}≤ω_{i,t}^{d}Q_{i,max}^{d} (33)

ω_{i,t}^{c}Q_{i,min}^{c}≤Q_{i,t}^{c}≤ω_{i,t}^{c}Q_{i,max}^{c} (34)

E_{i,t+1}^{CT}=E_{i,t}^{CT}+β_{c}Q_{i,t}^{c}−β_{d}Q_{i,t}^{d} (35)

E_{i,min}^{CT}≤E_{i,t}^{CT}≤E_{i,max}^{CT} (36)

wherein ω_{i,t}^{c} represents a heat storage state of the i^{th} heat storage device at the time t, with ω_{i,t}^{c}=1 indicating the device is in a heat storage state, and ω_{i,t}^{c}=0 indicating the device is in a heat release or idle state; represents a heat release state of the i^{th} heat storage device at the time t, with ω_{i,t}^{d}=1 indicating the device is in the heat release state and ω_{i,t}^{d}=0 indicating the device is in the heat storage or idle state, where it is likewise considered that the heat storage devices cannot store heat or release heat simultaneously at the same time; Q_{dc} represents a maximum power variation range of the heat storage devices, and Q_{i,t}^{c}, Q_{i,t}^{d}, and E_{i,t}^{CT} represent heat storage power, heat release power and heat storage capacity of the heat storage devices at the time t, respectively; Q_{i,min}^{c} and Q_{i,max}^{c} represent lower and upper limits of the heat storage power of the i^{th} heat storage device at the time t respectively; Q_{i,min}^{d} and Q_{i,max}^{d} represent lower and upper limits of the heat release power of the i^{th} heat storage device at the time t respectively; β_{c} and β_{d} represent heat storage and heat release coefficients respectively; and E_{i,min}^{CT} and E_{i,max}^{CT} represent lower and upper limits of the capacity of the i^{th} heat storage device respectively.

(3) Constraints for Gas Network

\textcircled{1} Constraints of Flow for Gas Production Wells:

Q_{w,min}≤Q_{w,t}≤Q_{w,max} (37)

wherein Q_{w,t} represents a gas production flow of the gas production well w at the time t; Q_{w,min} represents a minimum gas production flow allowed by the gas production well w; and Q_{w,max} represents a maximum gas production flow allowed by the gas production well w.

\textcircled{2} Constraints of Node Pressure:

pr_{m,min}≤pr_{m,t}≤pr_{m,max} (38)

wherein pr_{m,t} represents the pressure of a node m during the period t; pr_{m,min} represents the minimum pressure allowed at the node m; and pr_{m,max} represents the maximum pressure allowed at the node m.

\textcircled{3} Constraints of Gas Storage:

Natural gas can be stored by a gas storage device for flow adjustment and subsequent use:

E_{i,min}^{gas}≤E_{i,t}^{gas}≤E_{i,max}^{gas} (39)

−Qᵢⁱⁿ≤(E_{i,t}^{gas}−E_{i,t-1}^{gas})/Tₛ≤Qᵢ^{out} (40)

wherein E_{i,t}^{gas} represents the gas storage capacity of the i^{th} gas storage device at the time t; E_{i,min}^{gas} E_{i,max}^{gas} represents the minimum and maximum gas storage capacities of the i^{th} gas storage device; and Qᵢⁱⁿ and Qᵢ^{out} represents inlet and outlet gas flow limits of the i^{th} gas storage device respectively.

\textcircled{4} Pipeline Capacity Equation:

The amount of natural gas contained in a natural gas pipeline is related to the average pressure of the pipeline and the characteristics of the pipeline per se:

LP_{mn,t}=LP_{mn,t-1}−Q_{mn,t}^{out}+Q_{mn,t}ⁱⁿ (41)

LP_{mn,t}=Kₘₙ^{lp}(pr_{m,t}+pr_{n,t})/2 (42)

wherein LP_{mn,t} represents the amount of natural gas contained in the pipeline mn at the time t; Q_{mn,t}^{out} represents the average outlet gas flow of the pipeline mn at the time t; Q_{mn,t}ⁱⁿ represents the average inlet gas flow of the pipeline mn at the time t; Kₘₙ^{lp} represents a coefficient related to the pipeline per se; and pr_{n,t} represents the pressure at a node n at the time t.

\textcircled{5} Flow Equation for Natural Gas Pipeline:

The flow of a natural gas pipeline is related to the pressure at both ends of the pipeline and the characteristics of the pipeline per se, and the total number of pipelines in the natural gas pipeline network is supposed to Nₚ; and to ensure the safe operation of the pipelines, the pressure of the natural gas in the pipeline mn must be less than the maximum allowable operating pressure of this pipeline:

$$\begin{matrix}{\overline{Q}}_{mn , t} = sgn ( p {r}_{m , t} , {pr}_{n , t} ) {K}_{m n}^{gf} \sqrt{\vert {pr}_{m , t}^{2} - p {r}_{n , t}^{2} \vert} & ( 43 ) \\ {\overline{Q}}_{mn , t} = ( {Q}_{mn , t}^{o u t} + {Q}_{mn , t}^{in} ) \text{/} 2 & ( 44 ) \\ sgn ( {pr}_{m , t} , {pr}_{n , t} ) = \{ \begin{matrix}1 & {pr}_{m , t} \geq {pr}_{n , t} \\ - 1 & {pr}_{m , t} \leq {pr}_{n , t}\end{matrix} & ( 45 )\end{matrix}$$

wherein Q̅_{mn,t} represents the average flow of the pipeline mn at the time t; and Kₘₙ^{gf} represents a coefficient related to the temperature, length, diameter, friction and other factors of the pipeline per se.

\textcircled{6} Constraints for Compressor Stations

pr_{m,t}≤Γ_{c}pr_{n,t} (46)

wherein Γ_{c} is a coefficient of the compression stations.

\textcircled{7} Constraints of Flow Balance for Nodes of Pipeline Network:

According to the law of conservation of mass, an algebraic sum of natural gas masses flowing into and out of any node of the pipeline network should be 0:

$${\sum }_{n ∈ G ( m )} ( {Q}_{mn , t}^{o u t} - {Q}_{mn , t}^{in} ) + {\sum }_{i ∈ G ( m )} ( {E}_{i , t}^{gas} - {E}_{i , t - 1}^{gas} ) \text{/} {T}_{s} + {\sum }_{w ∈ G ( m )} {Q}_{w , t} + {\sum }_{g ∈ G ( m )} {N}_{g , t} = {Q}_{m , t}^{D} + {\overline{Q}}_{m , t}^{gas} \qquad ( 47 )$$

Wherein Q_{m,t}^{D} represents a natural gas load at a node m at the time t; Q̅_{m,t}^{gas} represents a natural gas flow corresponding to the indeterminacy power of the gas unit at the node m at the time t; N_{g,t} represents a load-shedding amount of the gas network at the time t, which is a relaxation variable; and G(m) represents a set of respective parameters related to the node m.

(4) Coupling Constraints

\textcircled{1} Constraints of Electricity-Heat Coupling for Combined Heat and Electricity Units:

Q_{i,t}^{chp}=λᵢ^{chp}P_{i,t}^{chp} (48)

wherein λᵢ^{chp} represents a heat/electricity ratio of the i^{th} combined heat and electricity unit.

\textcircled{2} Constraints of Electricity-Heat Coupling for Electric Boilers:

Q_{i,t}^{EB}=ηP_{i,t}^{EB} (49)

wherein η represents the heating efficiency of the i^{th} electric boiler, which is 0.98.

\textcircled{3} Coupling Constraints for Gas Units

As the electricity generation units of the electric power system and the load unit of the gas network, the gas units are connection points between the gas network and the electricity network; and a function relationship between gas consumption and power is:

Q̅_{i,t}^{gas}=fᵢ^{gas}(P̅_{i,t}^{gas})/HHV (50)

fᵢ^{gas}(P̅_{i,t}^{gas})=αᵢ^{g}(P̅_{i,t}^{gas})²+bᵢ^{g}P̅_{i,t}^{gas}+cᵢ^{g} (51)

P_{i,min}^{gas}≤P̅_{i,t}^{gas}≤P_{i,max}^{gas} (52)

wherein Q̅_{i,t}^{gas} represents a natural gas flow corresponding to indeterminacy power of the gas unit at a node i at the time t; P̅_{i,t}^{gas} represents the indeterminacy power of the gas unit at the node i at the time t; fᵢ^{gas} represents a heat consumption rate curve function of the i^{th} gas unit; HHV represents high-level heat value of natural gas, which is 1.026 MBtu/kcf in the present invention and is converted into about 9,130.69 kcal/m³; and aᵢ^{g}, and bᵢ^{g}, and cᵢ^{g} represent a coefficient of the heat consumption rate curve function.

S3, establish a data-driven distributed robust scheduling optimization model under mixed norms.

S31, divide optimization variables into three stages to process, and represent the deterministic electricity-heat-gas coordination optimized scheduling model built in step S2 in a matrix form.

The optimization variables are divided into three stages to process as follows: in view of startup and shutdown programs of regular units that have been given in a scheduling program, the multi-period timing regulation action of energy storage elements, and considering that the combined heat and electricity units and gas units are normally open, variables related to the startup and shutdown states, electricity storage, heat storage, and gas storage of regular units are classified as first-stage variables, i.e. variables containing no indeterminacy parameters and irrelated to scenario information, which are taken as robust decision variables and represented by x; variables related to the gas network but containing no output of the gas units are classified as second-stage variables, which are configured to check an optimized result of the master economic scheduling problem; and remaining variables (such as outputs of regular units, combined heat and electricity units and gas units, etc.) are classified as third-stage variables, which are taken as robust decision variables and represented by y, which is assumed to be regulatable flexibly according to the actual output of wind electricity

To ensure the visuality of analysis, the deterministic electricity-heat-gas coordination optimized scheduling model built in step S2 is represented in the following matrix form:

$$\begin{matrix}{min}_{x , γ} {a}^{T} x + {b}^{T} y + {c}^{T} ξ + {d}^{T} σ & ( 53 ) \\ s . t . Ax \leq d & ( 54 ) \\ B x = e & ( 55 ) \\ C y \leq D ξ & ( 56 ) \\ Gx + H y \leq g & ( 57 ) \\ Jx + K y = h & ( 58 )\end{matrix}$$

wherein ξ represents a predicted wind electricity output vector, indicating P_{i,t}^{we}; σ represents a load-shedding amount vector; a^{T}x represents startup-shutdown cost F₁₁, b^{T}y represents operating cost F₁₂, cost F₂ of combined heat and electricity unit and cost F₃ of gas unit, c^{T}ξ represents wind abandoning cost F₄, d^{T}σ represents load-shedding cost F₅ ; a, b, c, d, e, g, and h are matrices composed of system parameters; A is a matrix composed of related parameters of inequality constraints in energy storage device constraints and regular unit startup-shutdown constraints; B is a matrix composed of related parameters of equality constraints in the energy storage device constraints and regular unit startup-shutdown constraints; C is a matrix composed of related parameters of constraints of third-stage decision variables; D is a matrix composed of related parameters of constraints of predicated output vectors of wind electricity; G and H are matrices composed of related parameters of inequality constraints in coupling relationship constraints between the first-stage variables and the third-stage variables; and J and K are matrices composed of related parameters of equality constraints in the coupling relationship constraints between the first-stage variables and the third-stage variables.

From (53), it can be observed that the objective function includes not only the first-stage and second-stage variables, but also the predicted output parameters and load-shedding parameters of the wind electricity, which correspond to equations (7) and (8) respectively; (54) and (55) represent constraints for electricity storage device, constraints for heat storage devices, constraints for gas storage devices, and startup and shutdown constraints for regular units; (56) represents a constraint relationship between the third-stage decision variables and the predicted output vector of wind electricity, which correspond to the wind electricity output constraint equation (27); and (57) and (58) represent a coupling relationship between the first-stage variables and the third-stage variables. From (53), it can be clearly seen that the wind electricity output vector (i.e. the indeterminacy parameter described later) exists only in the objective function and (56) related to the third-stage vector, and the constraints of this part do not include the first-stage variables.

S32, build an optimized scheduling model by using a distributed robust optimization method.

Due to higher indeterminacy of the predicted output of wind electricity in practice, the indeterminacy of the actual output of wind electricity needs to be fully considered during the scheduling process. In the present invention, with the combination of the advantages of robust optimization and stochastic optimization, the optimization scheduling model represented in a matrix form in step S31 is optimized by using the distributed robust optimization method; and the optimized scheduling model built by the distributed robust optimization method is:

$${min}_{x ∈ X , {y}_{0} ∈ Y ( x , {ξ}_{0} )} {a}^{T} x + {b}^{T} {y}_{0} + {c}^{T} {ξ}_{0} + {d}^{T} {σ}_{0} + {max}_{P ( ξ ) ∈ ψ} {E}_{P} [ {b}^{T} y + {c}^{T} ξ + {d}^{T} σ ] \qquad ( 59 )$$

wherein the subscript 0 represents a given scenario, and is recorded as a given scenario ξ₀; ξ₀, y₀ and σ₀ represent the predicted wind electricity output vector, the third-stage variables, and the load-shedding amount vector in the given scenario; ψ represents a value domain composed of probability values of respective discrete scenarios; P(ξ) represents a probability value of a predication scenario ξ; and E_{P} represents expected cost in the predication scenario ξ; X represents a feasible domain composed of (53)-(54); and Y (x, ξ₀) represents a feasible domain composed of constraints (57)-(58), and also represents a coupling relation between the first-stage variables and the third-stage variables in the given scenario;

From equation (59), it can be seen that the first stage not only optimizes the robust decision variables in the first stage, but also aims to optimize other costs in the basic prediction scenario. Compared with the robust optimized combination of regular units, the model built in the present invention can show the day-ahead scheduling output of the units, and the economy of the model is improved with the incorporation of the prediction scenario; and during the solving process of the third-stage variables, the model optimizes the expected costs in the prediction scenario ξ to obtain the worst probability distribution with the first-stage variables known.

S33, build a data-driven distributed robust scheduling optimization model under mixed norms by using a data driving method.

With the optimized model in the present invention, it is hard to obtain an indeterminacy distribution set, and thus, K finite discrete scenarios can be screened from the obtained M actual samples for characterizing possible values of the predicted wind electricity output vector; and since the probability distribution in respective discrete scenarios has indeterminacy, a data-driven robust distribution model is further obtained as follows:

$${min}_{x ∈ X , {y}_{0} ∈ Y ( x , {ξ}_{0} )} {a}^{T} x + {b}^{T} {y}_{0} + {c}^{T} {ξ}_{0} + {d}^{T} {σ}_{0} + {max}_{\{ {p}_{k} \} ∈ ψ} {min}_{{y}_{k} ∈ Y ( x , {ξ}_{k} )} {\sum }_{k = 1}^{K} {p}_{k} ( {b}^{T} {y}_{k} + {c}^{T} {ξ}_{k} + {d}^{T} {σ}_{k} ) \qquad ( 60 )$$

wherein the subscript k represents a scenario k, and is recorded as a given scenario ξₖ; ξₖ, yₖ and σₖ represent the predicted wind electricity output vector, the third-stage variables, and the load-shedding amount vector in the scenario k; and pₖ represents a probability value of the scenario k, with pₖ ε ψ;

$$ψ = \{ {p}_{k} ∈ {R}_{+} \vert {\sum }_{k = 1}^{K} {p}_{k} = 1 , k = 1 , … , K \} \qquad ( 61 )$$

wherein R₊ represents a real number greater than or equal to 0; in an actual situation, the obtained range ψ is greatly different from the actual situation since the range ψ calculated through (61) is too large; therefore, in the present invention, the range ψ is constrained by using two sets, namely, 1-norm and ∞-norm, thereby ensuring that the obtained range ψ is more in line with the actual operating data.

$$\begin{matrix}{ψ}_{1} = \{ {p}_{k} ∈ {R}_{+} \vert {\sum }_{k = 1}^{K} \vert {p}_{k} - {p}_{0. k} \vert \leq {θ}_{1} , {\sum }_{k = 1}^{K} {p}_{k} = 1 , k = 1 , … , K \} & ( 62 ) \\ {ψ}_{∞} = \{ {p}_{k} ∈ {R}_{+} \vert {max}_{1 \leq k \leq K} \vert {p}_{k} - {p}_{0. k} \vert \leq {θ}_{∞} , {\sum }_{k = 1}^{K} {p}_{k} = 1 , k = 1 , … , K \} & ( 63 )\end{matrix}$$

wherein p_{0.k} represents a probability value of the scenario k in historical data; θ₁, θ_{∞} represent an indeterminacy probability confidence sets constrained by using the 1-norm and ∞-norm, respectively, with pₖ satisfying the following confidence:

$$\begin{matrix}Pr \{ {\sum }_{k = 1}^{K} \vert {p}_{k} - {p}_{0. k} \vert \leq {θ}_{1} \} \geq 1 - 2 {Ke}^{- 2 M {θ}_{1} / K} & ( 64 ) \\ Pr \{ {max}_{1 \leq k \leq K} \vert {p}_{k} - {p}_{0. k} \vert \leq {θ}_{∞} \} \geq 1 - 2 {Ke}^{- 2 M {θ}_{∞}} & ( 65 )\end{matrix}$$

From inequations (64) to (65), it is not hard to find that the right portion of each inequation is the confidence level of a confidence set actually, therefore, the relationship between the confidence level α and θ₁ as well as θ_{∞} is as follows:

$${θ}_{1} = \frac{K}{2 M} ln \frac{2 K}{1 - α} \\ {θ}_{∞} = \frac{1}{2 M} ln \frac{2 K}{1 - α} \qquad ( 66 )$$

In addition, the equation (66) shows that as the quantity of the historical data increases, that is, with M increases, the estimated probability distribution will be closer to its true distribution, which means that, θ₁ and θ_{∞} will become smaller till reaching zero; and furthermore, for the same α, θ_{∞} will be less than θ₁. Due to the extremity and one-sidedness in the separate consideration of the 1-norm or ∞-norm, the model in the present invention takes the two norms into comprehensive consideration to constrain the indeterminacy probability confidence set.

Let the confidence levels on the right side of the inequations (64) and (65) be α₁ and α_{∞} respectively, so the equation (66) can be rewritten as:

$${θ}_{1} = \frac{K}{2 M} ln \frac{2 K}{1 - {α}_{1}} \\ {θ}_{∞} = \frac{1}{2 M} ln \frac{2 K}{1 - {α}_{∞}} \qquad ( 67 )$$

Then, the indeterminacy probability confidence set under a mixed norm constraint is built as follows:

$$ψ = \{ {p}_{k} ∈ {R}_{+} \vert {\sum }_{k = 1}^{K} \vert {p}_{k} - {p}_{0. k} \vert \leq {θ}_{1} , {max}_{1 \leq k \leq K} \vert {p}_{k} - {p}_{0. k} \vert \leq {θ}_{∞} , {\sum }_{k = 1}^{K} {p}_{k} = 1 , k = 1 , … , K \} \qquad ( 68 )$$

Finally, the equation (68) is a data-driven distributed robust scheduling optimization model under mixed norms.

S4, solve a master economic scheduling problem by the data-driven distributed robust scheduling optimization model under mixed norms built in step S3.

The master problem is to obtain an optimal solution that satisfies the conditions under a known finite bad probability distribution, providing the model (60) with a lower limit value U for the wind electricity indeterminacy subproblem and a constraint set, i.e. the Benders cut set ωₜ (which is empty in an initial state), added to the master problem by a gas network constraint check subproblem:

$$\begin{matrix}( MP ) {min}_{x ∈ X , {y}_{0} ∈ Y ( x , {ξ}_{0} ) , {y}_{k}^{m} ∈ Y ( x , {ξ}_{k} ) , L} {a}^{T} x + {b}^{T} {y}_{0} + {c}^{T} {ξ}_{0} + {d}^{T} {σ}_{0} + L & ( 69 ) \\ L \geq {\sum }_{k = 1}^{K} {p}_{k}^{m} ( {b}^{T} {y}_{k}^{m} + {c}^{T} {ξ}_{k} + {d}^{T} {σ}_{k} ) , ∀ m = 1 , … , n & ( 70 )\end{matrix}$$

S5, verify convergence of a wind electricity indeterminacy subproblem by the data-driven distributed robust scheduling optimization model under mixed norms built in step S3: if the wind electricity indeterminacy subproblem converges, go to step S6, otherwise go to step S4 and add a constraint to the master economic scheduling problem by using a CCG algorithm.

For the wind electricity indeterminacy subproblem, the worst probability distribution is found with the given first-stage variable x, and then provided to the master problem for further iterative calculations. The subproblem essentially provides an upper limit value for the model (60); and when a first-stage variable x* is given, the following subproblem can be obtained:

$$( SP ) L ( {x}^{*} ) = {max}_{\{ {p}_{k} \} ∈ ψ} {\sum }_{k = 1}^{K} {p}_{k} {min}_{{y}_{k} ∈ Y ( {x}^{*} , {ξ}_{k} )} ( {b}^{T} {y}_{k} + {c}^{T} {ξ}_{k} + {d}^{T} {σ}_{k} ) \qquad ( 71 )$$

From the subproblem (71), it can be seen that the inner min optimization problems in respective scenarios are linear programming problems and are mutually independent, and a parallel method can be used for simultaneous processing to accelerate the solving speed; and suppose that the inner optimization target value obtained in the scenario k is f(x*, ξₖ) after the first-stage variable x* is given, the subproblem is rewritten as:

$$L ( {x}^{*} ) = {max}_{\{ {p}_{k} \} ∈ ψ} {\sum }_{k = 1}^{K} f ( {x}^{*} , {ξ}_{k} ) {p}_{k} \qquad ( 72 )$$

The objective function of the model (72) is in a linear form, the feasible domain sets include ψ₁ and ψ_{∞}, and the feasible domains can be transformed according to the equations (62) and (63). Equivalent transformation is performed on absolute value constraints of ψ₁ and ψ_{∞}, and 0-1 auxiliary variables zₖ⁺, yₖ⁺ and yₖ⁻, zₖ⁻ are introduced to represent positive and negative offset tags of the probability pₖ relative to p_{0.k} respectively, wherein zₖ⁺ and zₖ⁻ represent positive and negative offsets tags under 1-norm, yₖ⁺ and yₖ⁻ represent positive and negative offsets tags under ∞-norm. The constraints of energy storage are similar, which satisfy the uniqueness of offset state:

zₖ⁺+zₖ⁻≤1, ∀k (73)

yₖ⁺+yₖ⁻≤1, ∀k (74)

The following constraints need to be added for limiting:

ρ₁+ρ_{∞}=1, ρ₁≥0, ρ_{∞}≥0 (75)

0≤pₖ⁺≤ρ₁zₖ⁺θ₁+ρ_{∞}yₖ⁺θ_{∞}, ∀k

0≤pₖ⁻≤ρ₁zₖ⁻θ₁+ρ_{∞}yₖ⁻θ_{∞}, ∀k

pₖ=p_{0.k}+pₖ⁺−pₖ⁻, ∀k (76)

wherein in the equations, pₖ⁺ and pₖ⁻ represent positive and negative offsets of pₖ respectively; ρ₁ and ρ_{∞} represent proportions of the 1-norm and the ∞-norm in the mixed norms respectively; and the original absolute value constraint is equivalently expressed as:

$$\begin{matrix}{\sum }_{k = 1}^{K} {p}_{k}^{+} + {p}_{k}^{-} \leq {ρ}_{1} {θ}_{1} + {ρ}_{∞} {θ}_{∞} , ∀ k & ( 77 ) \\ {p}_{k}^{+} + {p}_{k}^{-} \leq {ρ}_{1} {θ}_{1} + {ρ}_{∞} {θ}_{∞} , ∀ k & ( 78 )\end{matrix}$$

Based thereon, the model (72) is transformed into a mixed linear programming problem to be solved, and an optimal {pₖ*} is passed to an upper master problem for iterative calculation, wherein pₖ* represents the optimal probability value of the scenario k.

S6, check convergence of a gas network operation constraint subproblem: if the gas network operation constraint subproblem converges, end the calculation to obtain an optimal solution, otherwise, go to step S4 and add a Benders cut set constraint to the master economic scheduling problem.

The gas network constraint subproblem mainly represents the influence of a gas network side constraint on the scheduling output values of the gas units. This subproblem will perform a feasibility check on the output values of the gas units obtained by solving the master problem to ensure that the output values of the gas unit is feasible; and the objective function of the subproblem is:

$${max}_{{\overline{P}}_{i , t}^{gas} ∈ {G}_{gt} , t ∈ T} min {\sum }_{t = 1}^{T} {\sum }_{g ∈ {G}_{gt}} {λ}_{g} {N}_{g , t} \qquad ( 79 )$$

wherein λ_{g} represents a gas network load-shedding penalty coefficient, G_{gt} represents a parameter set related to the gas network at the time t, N_{g,t} represents a load-shedding amount of the gas network during the period t, P̅_{i,t}^{gas} represents indeterminate power of the gas unit at a node i at the time t, and T represents the total number of periods; and the constraints of the subproblem are as shown by equations (37)-(47) and equations (50)-(52).

When the objective function value of the subproblem is greater than 0, it indicates that there is an unfeasible portion in the output values of the gas units as solved for the master problem under the operating constraint at the gas network side; a constraint, i.e. a Benders cut set, is added to the master problem here by using a Benders algorithm; then it is returned to the master problem for resolving, wherein the Benders cut set generated by multiple iterations is always valid throughout the whole iteration process and must be all added to the constraint set of the master problem; and when the objective function of the subproblem is 0, no new Benders cut set is generated, and the algorithm converges here to end the calculation.

The Benders cut set is expressed as follows:

$${ω}_{t} ( μ , P , {P}^{chp} , {P}^{g a s} ) = {\hat{ω}}_{t} + {\sum }_{i = 1}^{{N}_{G}} {σ}_{i , t}^{p} ( {P}_{i , t} {μ}_{i , t} - {\hat{P}}_{i , t} {\hat{μ}}_{i , t} ) + {\sum }_{i = 1}^{{N}_{C}} {σ}_{i , t}^{c h p} ( {P}_{i , t}^{c h p} - {\hat{P}}_{i , t}^{c h p} ) + {\sum }_{i = 1}^{{N}_{g}} {σ}_{i , t}^{gas} ( {P}_{i , t}^{gas} - {\hat{P}}_{i , t}^{gas} ) \leq 0 \qquad ( 80 )$$

wherein μ represents a set of startup-shutdown parameters; P represents a set of active output parameters of the regular units; P^{chp} represents a set of active output parameters of the combined heat and electricity unit; P^{gas} represents a set of active output parameters of the gas units; \hat{ω}ₜ represents a target value of a subproblem during the period t; μ_{i,t} represents a startup and shutdown flag of the i^{th} regular unit during the period t, with 1 representing a startup state, and 0 representing a shutdown state; P_{i,t} represents an active output of the i^{th} regular unit during the period t; P_{i,t}^{chp} represents an electric power output of the i^{th} combined heat and electricity unit during the period t; P_{i,t}^{chp} represents an active output of the i^{th} gas unit during the period t; N_{C} represents the number of combined heat and electricity units; N_{C} represents the number of combined heat and electricity units; and N_{g} represents the number of the gas units.

\hat{ω}ₜ represents the target value of the subproblem during the period t; \hat{μ}_{i,t}, \hat{P}_{i,t}, \hat{P}_{i,t}^{chp}, and \hat{P}_{i,t}^{gas} represent the startup and shutdown states, an output of the regular units, an output of the combined heat and electricity units and an output of the gas units during the corresponding period t when the subproblem is solved, respectively; σ_{i,t}^{p}, σ_{i,t}^{chp}, and σ_{i,t}^{gas} are Lagrangian multipliers, respectively representing sensitivities of the output changes of the regular units, the combined heat and electricity units and the gas units to the objective function value of the subproblem. By adding the Benders cut set to the master problem, when the master problem is solved in the next iteration, the output of each unit and the startup and shutdown states of the regular units will be regulated to eliminate non-zero relaxation variables, thereby implementing the checking of the subproblem by the gas network constraints.

A data-driven three-stage scheduling method for electricity, heat and gas networks based on wind electricity indeterminacy includes a solving process as follows:

\textcircled{1} Let L_{B}=0, U_{B}=+∞, n=1;

\textcircled{2}Solve the CCG master problem to obtain an optimal decision result (x*, y₀*, yₖ^{m*}, a^{T}x* +b^{T}y₀*+c^{T}ξ₀+d^{T}σ₀+L*), and update the lower limit value L_{B}=max {L_{B}, a^{T}x* +b^{T}y₀*+c^{T}ξ₀+d^{T}σ₀+L*};

\textcircled{3} Fix x* to solve the CCG subproblem to obtain the optimal solution {pₖ*} and an optimal objective function value L(x*). Update the upper limit value U_{B}=min {U_{B}, a^{T}x* +b^{T}y₀*+c^{T}ξ₀+d^{T}σ₀+L(x*)}. If (U_{B}−L_{B})≤ε, the iteration is stopped, and the optimal solution x* is returned; otherwise, the bad probability distribution pₖⁿ⁺¹=pₖ*, ∀k of the master problem is updated, and new variables yₖ^{m} are defined and constraints Y (x, ξₖ) related to the new variables are added, in the master problem;

\textcircled{4} Update n=n+1, and Return to Step \textcircled{2};

\textcircled{5} Solve a Benders decomposition subproblem; if the objective function of the subproblem is greater than 0, the Benders cut set is generated and added to the constraint set of the master problem; go to step \textcircled{4}, if the objective function of the subproblem is 0, the constraint check conditions of the subproblem are satisfied, and a new Benders cut set will not be generated, determining that the algorithm converges;

\textcircled{6} End the Calculation.

Starting from the practical application of the optimized scheduling model, the present invention introduces a deterministic electricity-heat-gas coordination optimized scheduling model; a distributed robust scheduling optimization model under mixed norms is established by using a data driving method; the optimized variables are classified into three stages; the CCG algorithm is used to add constraints to the master problem to verify the feasibility of the wind electricity indeterminacy subproblem; and meanwhile, the Benders cut set constraint is added to the master problem to ensure the convergence of the gas network operation constraint subproblem, thereby obtaining the optimal solution. The present invention can solve the problem of wind abandoning and power brownout caused by the wind electricity indeterminacy problem, and the problems on one-sidedness, conservativeness and economy of the traditional stochastic programming and robust optimization methods to different degrees, and can provide a more reliable method for studying the coordination and optimization of the integrated electricity-heat-gas system.

Beneficial effects: the present invention provides a data-driven three-stage scheduling method for electricity, heat and gas networks based on wind electricity indeterminacy, which, under the operation constraints of an electricity network, a heat network and a gas network, can reasonably arrange the outputs of respective units and effectively utilize an energy storage device to respond to the output indeterminacy of wind electricity, thereby further improving the consumption of the wind electricity and the utilization ratio of the energy, and ensuring the economy in the operation of the integrated system.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a flowchart of the overall implementation of the present invention;

FIG. 2 is a flowchart of establishing a data-driven distributed robust scheduling optimization model under mixed norms according to the present invention.

### DESCRIPTION OF THE EMBODIMENTS

The present invention will be further described below with reference to the accompanying drawings.

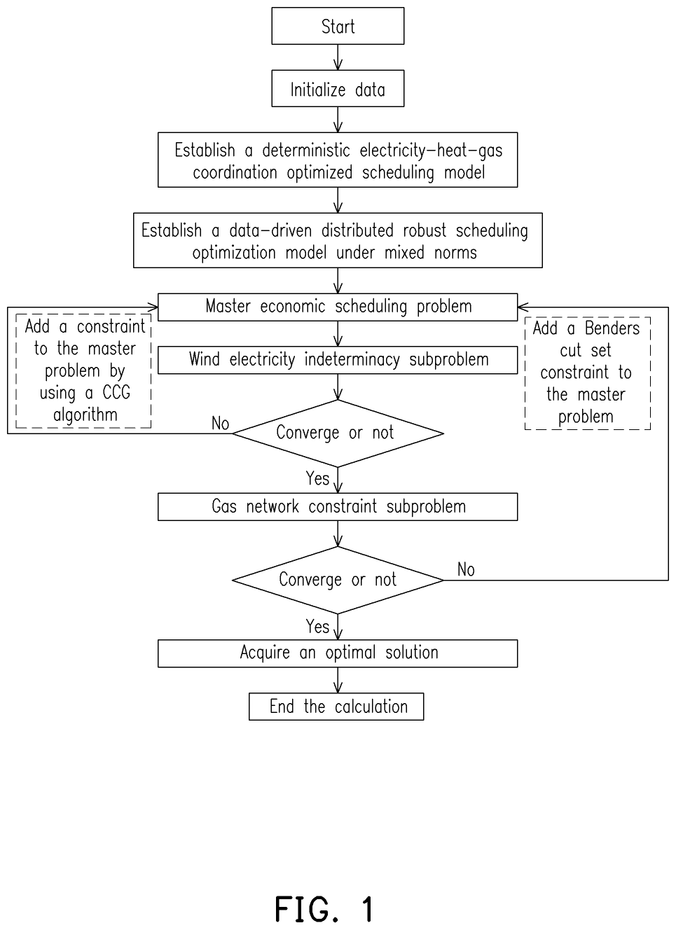

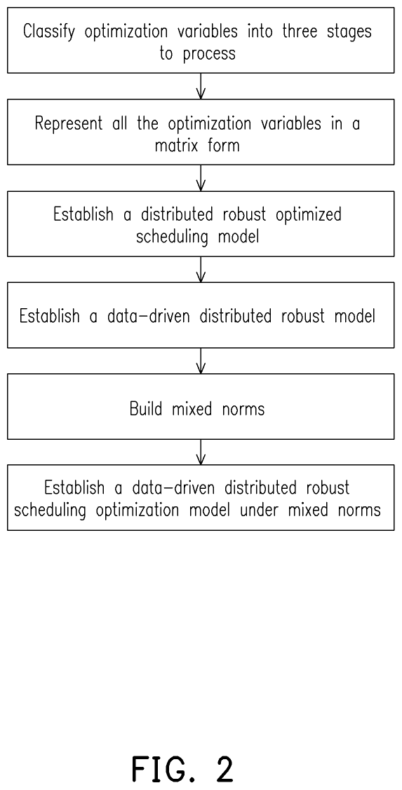

As shown in FIGS. 1 and 2, a data-driven three-stage scheduling method for electricity, heat and gas networks based on wind electricity indeterminacy specifically includes the following steps:

S1, acquiring calculation data and initializing variables and the calculation data;

S2, establishing a deterministic electricity-heat-gas coordination optimized scheduling model, to be specific:

S21, establishing an objective function of an integrated system;

S22, establishing equality and inequality constraints of the integrated system;

S3, establishing a data-driven distributed robust scheduling optimization model under mixed norms, to be specific:

S31, dividing optimization variables into three stages to process, and representing the deterministic electricity-heat-gas coordination optimized scheduling model built in step S2 in a matrix form;

S32, building an optimized scheduling model by using a distributed robust optimization method;

S33, building a data-driven distributed robust scheduling optimization model under mixed norms by using a data driving method;

S4, solving a master economic scheduling problem by the data-driven distributed robust scheduling optimization model under mixed norms built in step S3;

S5, verifying convergence of a wind electricity indeterminacy subproblem by the data-driven distributed robust scheduling optimization model under mixed norms built in step S3: if the wind electricity indeterminacy subproblem converges, going to step S6, otherwise going to step S4 and adding a constraint to the master economic scheduling problem by using a CCG algorithm;

S6, checking convergence of a gas network operation constraint subproblem, if the gas network operation constraint subproblem converges, ending the calculation to obtain an optimal solution, otherwise, going to step S4 and adding a Benders cut set constraint to the master economic scheduling problem.

To make the present invention more clear, a detailed description of relevant contents will be provided below.

Step 1: dividing optimization variables into three stages to process, and representing the deterministic electricity-heat-gas coordination optimized scheduling model built in step S2 in a matrix form:

The optimization variables are divided into three stages as follows to process: in view of startup and shutdown programs of regular units that have been given in a scheduling program, and the multi-period timing regulation action of energy storage elements, and considering that the combined heat and electricity units and gas units are normally open, variables related to the startup and shutdown states, electricity storage, heat storage, and gas storage of regular units are classified as first-stage variables in the present invention, i.e. variables containing no indeterminacy parameters and irrelated to scenario information, which are taken as robust decision variables and represented by x; variables related to the gas network but containing no output of the gas units are classified as second-stage variables, which are configured to check an optimized result of the master economic scheduling problem; and remaining variables (such as outputs of regular units, combined heat and electricity units and gas units, etc.) are classified as third-stage variables, which are taken as robust decision variables and represented by y . To ensure the visuality of analysis, the deterministic electricity-heat-gas coordination optimized scheduling model is represented in the following matrix form:

$$\begin{matrix}{min}_{x , y} {a}^{T} x + {b}^{T} y + {c}^{T} ξ + {d}^{T} σ & ( 1 a ) \\ s . t . Ax \leq d & ( 1 a ) \\ Bx = e & ( 1 a ) \\ C y \leq D ξ & ( 1 a ) \\ Gx + H y \leq g & ( 1 a ) \\ Jx + K y = h & ( 1 a )\end{matrix}$$

wherein ξ represents a predicted wind electricity output vector, indicating p_{i,t}^{we}, σ represents a load-shedding amount vector; a^{T}x represents startup-shutdown cost , F₁₁, b^{T}y represents operating cost F₁₂, cost F₂ of combined heat and electricity unit and cost F₃ of gas unit, c^{T}ξ represents wind abandoning cost F₄, d^{T}σ represents load-shedding cost F₅; a, b, c, d, e, g, and h are matrices composed of system parameters; A is a matrix composed of related parameters of inequality constraints in energy storage device constraints and regular unit startup-shutdown constraints; B is a matrix composed of related parameters of equality constraints in the energy storage device constraints and regular unit startup-shutdown constraints; C is a matrix composed of related parameters of constraints of third-stage decision variables; D is a matrix composed of related parameters of constraints of predicated output vectors of wind electricity; G and H are matrices composed of related parameters of inequality constraints in coupling relationship constraints between the first-stage variables and the third-stage variables; and J and K are matrices composed of related parameters of equality constraints in the coupling relationship constraints between the first-stage variables and the third-stage variables.

Step 2: building an optimized scheduling model by using a distributed robust optimization method.

Due to higher indeterminacy of the predicted output of wind electricity in practice, the indeterminacy of the actual output of wind electricity needs to be fully considered during scheduling. In the present invention, with the combination of the advantages of robust optimization and stochastic optimization, the optimization scheduling model represented in a matrix form in step S31 is optimized by using the distributed robust optimization method; and the optimized scheduling model built by the distributed robust optimization method is:

$${min}_{x ∈ X , {y}_{0} ∈ Y ( x , {ξ}_{0} )} {a}^{T} x + {b}^{T} {y}_{0} + {c}^{T} {ξ}_{0} + {d}^{T} {σ}_{0} + {max}_{P ( ξ ) ∈ ψ} {E}_{P} [ {b}^{T} y + {c}^{T} ξ + {d}^{T} σ ] \qquad ( 2 a )$$

wherein the subscript 0 represents a given scenario, and is recorded as a given scenario ξ₀; ξ₀, y₀ and σ₀ represent the predicted wind electricity output vector, the third-stage variables, and the load-shedding amount vector in the given scenario; ψ represents a value domain composed of probability values of respective discrete scenarios; P(ξ) represents a probability value of a predication scenario ξ; and E_{P} represents expected cost in the predication scenario ξ.

Step 3: building a distributed robust scheduling optimization model under mixed norms by using a data driving method.

With the optimized model in the present invention, it is hard to obtain an indeterminacy distribution set, and thus, K finite discrete scenarios can be screened from the obtained M actual samples for characterizing possible values of the predicted wind electricity output vector; and since the probability distribution in respective discrete scenarios has indeterminacy, a data-driven robust distribution model is further obtained as follows:

$${min}_{x ∈ X , {y}_{0} ∈ Y ( x , {ξ}_{0} )} {a}^{T} x + {b}^{T} {y}_{0} + {c}^{T} {ξ}_{0} + {d}^{T} {σ}_{0} + {max}_{\{ {p}_{k} \} ∈ ψ} {min}_{{y}_{k} ∈ Y ( x , {ξ}_{k} )} {\sum }_{k = 1}^{K} {p}_{k} ( {b}^{T} {y}_{k} + {c}^{T} {ξ}_{k} + {d}^{T} {σ}_{k} ) \qquad ( 3 a )$$

wherein the subscript k represents a scenario k, and is recorded as a given scenario ξₖ; ξₖ, yₖ and σₖ represent the predicted wind electricity output vector, the third-stage variables, and the load-shedding amount vector in the scenario k; and pₖ represents a probability value of the scenario k, with pₖ ε ψ.

$$ψ = \{ {p}_{k} ∈ {R}_{+} \vert {\sum }_{k = 1}^{K} {p}_{k} = 1 , k = 1 , … , K \} \qquad ( 3 b )$$

wherein R₊ represents a real number greater than or equal to 0; in an actual situation, the obtained range ψ is greatly different from the actual situation since the range ψ calculated through (3b) is too large; therefore, the range ψ is constrained by using two sets, namely, 1-norm and ∞-norm, in the present invention, thereby ensuring that the obtained range ψ is more in line with the actual operating data.

$$\begin{matrix}{ψ}_{1} = \{ {p}_{k} ∈ {R}_{+} \vert {\sum }_{k = 1}^{K} \vert {p}_{k} - {p}_{0. k} \vert \leq {θ}_{1} , {\sum }_{k = 1}^{K} {p}_{k} = 1 , k = 1 , … , K \} & ( 3 c ) \\ {ψ}_{∞} = \{ {p}_{k} ∈ {R}_{+} \vert {max}_{1 \leq k \leq K} \vert {p}_{k} - {p}_{0. k} \vert \leq {θ}_{∞} , {\sum }_{k = 1}^{K} {p}_{k} = 1 , k = 1 , … , K \} & ( 3 d )\end{matrix}$$

wherein p_{0.k} represents a probability value of the scenario k in historical data; θ₁, θ_{∞} represents an indeterminacy probability confidence sets constrained by using the 1-norm and ∞-norm, respectively, with pₖ satisfying the following confidence:

$$\begin{matrix}Pr \{ {\sum }_{k = 1}^{K} \vert {p}_{k} - {p}_{0. k} \vert \leq {θ}_{1} \} \geq 1 - 2 {Ke}^{- 2 M {θ}_{1} \text{/} K } & ( 3 e ) \\ Pr \{ {max}_{1 \leq k \leq K} \vert {p}_{k} - {p}_{0. k} \vert \leq {θ}_{∞} \} \geq 1 - 2 {Ke}^{- 2 M {θ }_{∞}} & ( 3 f )\end{matrix}$$

From equations (3e) to (3f), it is not hard to find that the right portion of each inequation is the confidence level of a confidence set actually, therefore, the relationship between the confidence level α and θ₁ as well as θ_{∞} is as follows:

$${θ}_{1} = \frac{K}{2 M} ln \frac{2 K}{1 - α} \\ {θ}_{∞} = \frac{1}{2 M} ln \frac{2 K}{1 - α} \qquad ( 3 g )$$

In addition, the equation (3g) shows that as the quantity of the historical data increases, that is, with M increases, the estimated probability distribution will be closer to its true distribution, which means that, θ₁ and θ_{∞} will become smaller till reaching zero; and furthermore, for the same α, θ_{∞} will be less than θ₁. Due to the extremity and one-sidedness in the separate consideration of the 1-norm or ∞-norm, the model in the present invention takes the two norms into comprehensive consideration to constrain the indeterminacy probability confidence set.

Let the confidence levels on the right side of the inequations (3e) and (3f) be α₁ and α_{∞} respectively, so the equation (3g) can be rewritten as:

$${θ}_{1} = \frac{K}{2 M} ln \frac{2 K}{1 - {α}_{1}} \\ {θ}_{∞} = \frac{1}{2 M} ln \frac{2 K}{1 - {α}_{∞}} \qquad ( 3 h )$$

Then, the indeterminacy probability confidence set under a mixed norm constraint is built as follows:

$$ψ = \{ {p}_{k} ∈ {R}_{+} \vert {\sum }_{k = 1}^{K} \vert {p}_{k} - {p}_{0. k} \vert \leq {θ}_{1} , {max}_{1 \leq k \leq K} \vert {p}_{k} - {p}_{0. k} \vert \leq {θ}_{∞} , {\sum }_{k = 1}^{K} {p}_{k} = 1 , k = 1 , … , K \} \qquad ( 3 i )$$

Finally, the equation (3i) is a data-driven distributed robust scheduling optimization model under mixed norms.

Step 4: Handling of a wind electricity indeterminacy subproblem:

For the wind electricity indeterminacy subproblem, the worst probability distribution is found with the given first-stage variable x , and then provided to the master problem for further iterative calculations. The subproblem essentially provides an upper limit value for the model (3a); and when a first-stage variable x* is given, the following subproblem can be obtained:

$$( SP ) L ( {x}^{*} ) = {max}_{\{ {p}_{k} \} ∈ ψ} {\sum }_{k = 1}^{K} {p}_{k} {min}_{{y}_{k} ∈ Y ( {x}^{*} , {ξ}_{k} )} ( {b}^{T} {y}_{k} + {c}^{T} {ξ}_{k} + {d}^{T} {σ}_{k} ) \qquad ( 4 a )$$

From the subproblem (4a), it can be seen that the inner min optimization problems in respective scenarios are linear programming problems and are mutually independent, and a parallel method can be used for simultaneous processing to accelerate the solving speed; and suppose that the inner optimization target value obtained in the scenario k is f(x*, ξₖ) after the first-stage variable x* is given, the subproblem is rewritten as:

$$L ( {x}^{*} ) = {max}_{\{ {p}_{k} \} ∈ ψ} {\sum }_{k = 1}^{K} f ( {x}^{*} , {ξ}_{k} ) {p}_{k} \qquad ( 4 b )$$

The objective function of the model (4b) is in a linear form, the feasible domain sets include ψ₁ and ψ_{∞}, and the feasible domains can be transformed according to the equations (3c) and (3d). Equivalent transformation is performed on absolute value constraints of ψ₁ and ψ_{∞}, and 0-1 auxiliary variables zₖ⁺, yₖ⁺ and yₖ⁻, zₖ⁻ are introduced to represent positive and negative offset tags of the probability pₖ relative to p_{0.k} respectively, wherein zₖ⁺ and zₖ⁻ represent positive and negative offsets tags under 1-norm, yₖ⁺ and yₖ⁻ represent positive and negative offsets tags under ∞-norm. The constraints of energy storage are similar, which satisfy the uniqueness of offset state:

zₖ⁺+zₖ⁻≤1, ∀k (4c)

yₖ⁺+yₖ⁻≤1, ∀k (4d)

The following constraints need to be added for limiting:

ρ₁+ρ_{∞}=1, ρ₁≥0, ρ_{∞}≥0 (4e)

0≤p; pₖ⁺≤ρ₁zₖ⁺θ₁+ρ_{∞}yₖ⁺θ_{∞}, ∀k

0≤pₖ⁻≤ρ₁zₖ⁻θ₁+ρ_{∞}yₖ⁻θ_{∞}, ∀k

pₖ=p_{0.k}+pₖ⁺−pₖ⁻, ∀k (4f)

wherein in the equations, pₖ⁺ and pₖ⁻ represent positive and negative offsets of pₖ respectively; and ρ₁ and ρ_{∞} represent proportions of the 1-norm and the ∞-norm in the mixed norms respectively; and the original absolute value constraint is equivalently expressed as:

$$\begin{matrix}{\sum }_{k = 1}^{K} {p}_{k}^{+} + {p}_{k}^{-} \leq {ρ}_{1} {θ}_{1} + {ρ}_{∞} {θ}_{∞} , ∀ k & ( 4 g ) \\ {p}_{k}^{+} + {p}_{k}^{-} \leq {ρ}_{1} {θ}_{1} + {ρ}_{∞} {θ}_{∞} , ∀ k & ( 4 h )\end{matrix}$$

Based thereon, the model (4b) is transformed into a mixed linear programming problem to be solved, and an optimal {pₖ*} is passed to an upper master problem for iterative calculation, wherein pₖ* represents the optimal probability value of the scenario k.

Step 5: Handling of a gas network constraint subproblem:

The gas network constraint subproblem mainly represents the influence of a gas network side constraint on the scheduling output values of the gas units. This subproblem will perform a feasibility check on the output values of the gas units obtained by solving the master problem to ensure that the output values of the gas unit is feasible; and the objective function of the subproblem is:

$${max}_{{\overline{P}}_{i , j}^{gas} ∈ {G}_{gt} , t ∈ T} min {\sum }_{t = 1}^{T} {\sum }_{g ∈ {G}_{gt}} {λ}_{g} {N}_{g , t} \qquad ( 5 a )$$

wherein λ_{g} represents a gas network load-shedding penalty coefficient, G_{gt} represents a parameter set related to the gas network at the time t, N_{g,t} represents a load-shedding amount of the gas network during the period t, P̅_{i,t}^{gas} represents indeterminate power of the gas unit at a node i at the time t, and T represents the total number of periods.

When the objective function value of the subproblem is greater than 0, it indicates that there is an unfeasible portion in the output values of the gas units as solved for the master problem under the operating constraint at the gas network side; a constraint, i.e. a Benders cut set, is added to the master problem here by using a Benders algorithm; then it is returned to the master problem for resolving, wherein the Benders cut set generated by multiple iterations is always valid throughout the whole iteration process and must be all added to the constraint set of the master problem; and when the objective function of the subproblem is 0, no new Benders cut set is generated, and the algorithm converges here to end the calculation.

The Benders cut set is expressed as follows:

$${ω}_{t} ( μ , P , {P}^{chp} , {P}^{g a s} ) = {\hat{ω}}_{t} + {\sum }_{i = 1}^{{N}_{G}} {σ}_{i , t}^{p} ( {P}_{i , t} {μ}_{i , t} - {\hat{P}}_{i , t} {\hat{μ}}_{i , t} ) + {\sum }_{i = 1}^{{N}_{C}} {σ}_{i , t}^{c h p} ( {P}_{i , t}^{c h p} - {\hat{P}}_{i , t}^{c h p} ) + {\sum }_{i = 1}^{{N}_{g}} {σ}_{i , t}^{gas} ( {P}_{i , t}^{gas} - {\hat{P}}_{i , t}^{gas} ) \leq 0 \qquad ( 5 b )$$

wherein μ represents a set of startup-shutdown parameters; P represents a set of active output parameters of the regular units; P^{chp} represents a set of active output parameters of the combined heat and electricity unit; P^{gas} represents a set of active output parameters of the gas units; \hat{ω}ₜ represents a target value of a subproblem during the period t; μ_{i,t} represents a startup and shutdown flag of the i^{th} regular unit during the period t, with 1 representing a startup state, and 0 representing a shutdown state; P_{i,t} represents an active output of the i^{th} regular unit during the period t; P_{i,t}^{chp} represents an electric power output of the i^{th} combined heat and electricity unit during the period t; P_{i,t}^{gas} represents an active output of the i^{th} gas unit during the period t; N_{C} represents the number of combined heat and electricity units; N_{C} represents the number of combined heat and electricity units; and N_{g} represents the number of the gas units.

\hat{ω}ₜ represents the target value of the subproblem during the period t; \hat{μ}_{i,t}, \hat{P}_{i,t}, \hat{P}_{i,t}^{chp}, and \hat{P}_{i,t}^{gas} represent the startup and shutdown states, an output of the regular units, an output of the combined heat and electricity units and an output of the gas units during the corresponding period t when the subproblem is solved, respectively; σ_{i,t}^{p}, σ_{i,t}^{chp}, and σ_{i,t}^{gas} are Lagrangian multipliers, respectively representing sensitivities of the output changes of the regular units, the combined heat and electricity units and the gas units to the objective function value of the subproblem. By adding the Benders cut set to the master problem, when the master problem is solved in the next iteration, the output of each unit and the startup and shutdown states of the regular units will be regulated to eliminate non-zero relaxation variables, thereby implementing the checking of the subproblem by the gas network constraints.

The description above only provides preferred embodiments of the present invention. It should be noted that for those of ordinary skills in the art, various improvements and modifications can be made without departing from the principle of the present invention and shall be construed as falling within the protection scope of the present invention.

What is claimed is:

1. A data-driven three-stage scheduling method for electricity, heat and gas networks based on wind electricity indeterminacy, comprising the following steps:
S1, acquiring calculation data and initializing variables and the calculation data;
S2, establishing a deterministic electricity-heat-gas coordination optimized scheduling model, comprising: S21, establishing an objective function of an integrated system; and S22, establishing equality and inequality constraints of the integrated system;
S3, establishing a data-driven distributed robust scheduling optimization model under mixed norms, comprising:
S31, dividing optimization variables into three stages to process, and representing the deterministic electricity-heat-gas coordination optimized scheduling model built in step S2 in a matrix form; S32, building an optimized scheduling model by using a distributed robust optimization method; and S33, building the data-driven distributed robust scheduling optimization model under mixed norms by using a data driving method;
S4, solving a master economic scheduling problem by the data-driven distributed robust scheduling optimization model under mixed norms built in step S3;
S5, verifying convergence of a wind electricity indeterminacy subproblem by the data-driven distributed robust scheduling optimization model under mixed norms built in step S3, if the wind electricity indeterminacy subproblem converges, going to step S6, otherwise going to step S4 and adding a constraint to the master economic scheduling problem by using a CCG algorithm; and
S6, checking convergence of a gas network operation constraint subproblem, if the gas network operation constraint subproblem converges, ending the calculation to obtain an optimal solution, otherwise, going to step S4 and adding a Benders cut set constraint to the master economic scheduling problem.

2. The data-driven three-stage scheduling method for electricity, heat and gas networks based on wind electricity indeterminacy according to claim 1, wherein in step S3, establishing the data-driven distributed robust scheduling optimization model under mixed norms comprises:
S31, dividing the optimization variables into the three stages to process, and representing the deterministic electricity-heat-gas coordination optimized scheduling model built in step S2 in the matrix form, wherein
dividing the optimization variables into the three stages to process comprises: classifying variables related to startup and shutdown status of conventional units, electricity storage, heat storage and gas storage as first-stage variables, represented by x; classifying variables related to the gas network but excluding outputs of gas units as second-stage variables; and classifying remaining variables as third-stage variables, represented by y;
the deterministic electricity-heat-gas coordination optimized scheduling model built in step S2 is represented in the following matrix form:
$$\begin{matrix}{min}_{x , y} {a}^{T} x + {b}^{T} y + {c}^{T} ξ + {d}^{T} σ & ( 3 a ) \\ s . t . Ax \leq d & ( 3 b ) \\ Bx = e & ( 3 c ) \\ C y \leq D ξ & ( 3 d ) \\ Gx + H y \leq g & ( 3 e ) \\ Jx + K y = h , & ( 3 f )\end{matrix}$$
wherein ξ represents a predicted wind electricity output vector; σ represents a load-shedding amount vector; a^{T}x represents startup-shutdown cost, b^{T}y represents operating cost, cost of combined heat and electricity unit and cost of gas unit, c^{T}ξ represents wind abandoning cost, d^{T}σ represents load-shedding cost; a, b, c, d, e, g, and h are matrices composed of system parameters; A is a matrix composed of related parameters of inequality constraints in energy storage device constraints and regular unit startup-shutdown constraints; B is a matrix composed of related parameters of equality constraints in the energy storage device constraints and regular unit startup-shutdown constraints; C is a matrix composed of related parameters of constraints of third-stage decision variables; D is a matrix composed of related parameters of constraints of predicated output vectors of wind electricity; G and H are matrices composed of related parameters of inequality constraints in coupling relationship constraints between the first-stage variables and the third-stage variables; and J and K are matrices composed of related parameters of equality constraints in the coupling relationship constraints between the first-stage variables and the third-stage variables;
S32, building the optimized scheduling model by using the distributed robust optimization method;
the optimized scheduling model built by using the distributed robust optimization method is as follows:
$${min}_{x ∈ X , {y}_{0} ∈ Y ( x , {ξ}_{0} )} {a}^{T} x + {b}^{T} {y}_{0} + {c}^{T} {ξ}_{0} + {d}^{T} {σ}_{0} + {max}_{P ( ξ ) ∈ ψ} {E}_{P} [ {b}^{T} y + {c}^{T} ξ + {d}^{T} σ ] \qquad ( 3 g )$$
wherein, the subscript 0 represents a given scenario, and is recorded as a given scenario ξ₀; ξ₀, y₀, and σ₀ represent the predicated output vectors of wind electricity, the third-stage variables, and the load-shedding amount vector in the given scenarios; ψ represents a value domain composed of probability values of respective discrete scenarios; P(ξ) represents a probability value of a prediction scenario ξ; E_{P} represents expected cost under the prediction scenario ξ; X represents a feasible domain composed of (3b)-(3c); and Y(x, ξ₀) represents a feasible domain composed of (3d)-(3f) constraints;
S33, building the data-driven distributed robust scheduling optimization model under mixed norms by using the data driving method, wherein
K finite discrete scenarios are screened from the obtained M actual samples for characterizing possible values of the predicted wind electricity output vector, so as to further obtain a data-driven robust distribution model as follows:
$${min}_{x ∈ X , {y}_{0} ∈ Y ( x , {ξ}_{0} )} {a}^{T} x + {b}^{T} {y}_{0} + {c}^{T} {ξ}_{0} + {d}^{T} {σ}_{0} + {max}_{\{ {p}_{k} \} ∈ ψ} {min}_{{y}_{k} ∈ Y ( x , {ξ}_{y} )} {\sum }_{k = 1}^{K} {P}_{k} ( {b}^{T} {y}_{k} + {c}^{T} {ξ}_{k} + {d}^{T} {σ}_{k} ) \qquad ( 3 h )$$
wherein the subscript k represents a scenario k, and is recorded as a given scenario ξₖ; ξₖ, yₖ and σₖ represent the predicted wind electricity output vector, the third-stage variables, and the load-shedding amount vector in the scenario k; and pₖ, represents a probability value of the scenario k, with pₖ ε ψ;
$$ψ = \{ {p}_{k} ∈ {R}_{+} \vert {\sum }_{k = 1}^{K} {p}_{k} = 1 , k = 1 , … , K \} \qquad ( 3 i )$$
wherein R₊ represents a real number greater than or equal to 0; a ψ range is constrained by two sets of 1-norm and ∞-norm as follows:
$$\begin{matrix}{ψ}_{1} = \{ {p}_{k} ∈ {R}_{+} \vert {{\sum }_{k = 1}}^{K} \vert {p}_{k} - {p}_{0 \cdot k} \vert \leq {θ}_{1} , {\sum }_{k = 1}^{K} {p}_{k} = 1 , k = 1 , … , K \} & ( 3 j ) \\ {ψ}_{∞} = \{ {p}_{k} ∈ {R}_{+} \vert {max}_{1 \leq k \leq K} \vert {p}_{k} - {p}_{0 \cdot k} \vert \leq {θ}_{∞} , {\sum }_{k = 1}^{K} {p}_{k} = 1 , k = 1 , … , K \} & ( 3 k )\end{matrix}$$
wherein p_{0.k}, represents a probability value of the scenario k in historical data; θ₁, θ_{∞} represent an indeterminacy probability confidence sets constrained by using the 1-norm and ∞-norm, respectively, with pₖ satisfying the following confidence:
$$\begin{matrix}Pr \{ {{\sum }_{k = 1}}^{K} \vert {p}_{k} - {p}_{0 \cdot k} \vert \leq {θ}_{1} \} \geq 1 - 2 {Ke}^{- 2 M {θ}_{1} / K} & ( 3 l ) \\ Pr \{ {max}_{1 \leq k \leq K} \vert {p}_{k} - {p}_{0 \cdot k} \vert \leq {θ}_{∞} \} \geq 1 - 2 {Ke}^{- 2 M {θ}_{∞}} & ( 3 m )\end{matrix}$$
a relationship between a confidence level α and θ₁ as well as θ_{∞} is as follows:
$${θ}_{1} = \frac{K}{2 M} ln \frac{2 K}{1 - α} \\ {θ}_{∞} = \frac{1}{2 M} ln \frac{2 K}{1 - α} \qquad ( 3 n )$$
the indeterminacy probability confidence set under a mixed norm constraint is built as follows:
$$ψ = \{ {p}_{k} ∈ {R}_{+} \vert {{\sum }_{k = 1}}^{K} \vert {p}_{k} - {p}_{0 \cdot k} \vert \leq {θ}_{1} , {max}_{1 \leq k \leq K} \vert {p}_{k} - {p}_{0 \cdot k} \vert \leq {θ}_{∞} , {\sum }_{k = 1}^{K} {p}_{k} = 1 , k = 1 , … , K \} \qquad ( 3 p )$$
finally, the equation (3p) is the data-driven distributed robust scheduling optimization model under mixed norms.

3. The data-driven three-stage scheduling method for electricity, heat and gas networks based on wind electricity indeterminacy according to claim 1, wherein in step S5, the wind electricity indeterminacy subproblem is processed as follows:
when a first-stage variable x* is given, obtaining a subproblem as follows:
$$( SP ) L ( {x}^{*} ) = {max}_{\{ {p}_{k} \} ∈ ψ} {\sum }_{k = 1}^{K} {p}_{k} {min}_{{y}_{k} ∈ Y ( {x}^{*} , {ξ}_{k} )} ( {b}^{T} {y}_{k} + {c}^{T} {ξ}_{k} + {d}^{T} {σ}_{k} ) \qquad ( 5 a )$$
assuming that a target inner optimization value f(x*, ξₖ) in the scenario k is obtained after the first stage variable x* is given, then rewriting the subproblem as:
$$L ( {x}^{*} ) = {max}_{\{ {p}_{k} \} ∈ ψ} {\sum }_{k = 1}^{K} f ( {x}^{*} , {ξ}_{k} ) {p}_{k} \qquad ( 5 b )$$
performing equivalent transformation on absolute value constraints of ψ₁ and ψ_{∞}, and introducing 0-1 auxiliary variables zₖ⁺, yₖ⁺ and yₖ⁻, zₖ⁻, which represent positive and negative offset tags of the probability pₖ relative to p_{0.k} respectively, wherein zₖ⁺ and zₖ⁻ represent positive and negative offsets tags under 1-norm, yₖ⁺ and yₖ⁻ represent positive and negative offsets tags under ∞-norm, which satisfy the uniqueness of offset state:
zₖ⁺+zₖ⁻≤1, ∀k (5c)
yₖ⁺+yₖ⁻≤1, ∀k (5d)
adding the following constraints for limiting:
ρ₁+ρ_{∞}=1, ρ₁≥0, ρ_{∞}≥0 (5e)
0≤pₖ⁺≤ρ₁zₖ⁺θ₁+ρ_{∞}yₖ⁺θ_{∞}, ∀k
0≤pₖ⁻≤ρ₁zₖ⁻θ₁+ρ_{∞}yₖ⁻θ_{∞}, ∀k
pₖ−p_{0.k}+pₖ⁺−pₖ⁻, ∀k (5f)
wherein in the equations, pₖ⁺ and pₖ⁻ represent positive and negative offsets of pₖ respectively; and ρ₁ and ρ_{∞} represent proportions of the 1-norm and the ∞-norm in the mixed norms respectively; and the original absolute value constraint is equivalently expressed as:
$$\begin{matrix}{\sum }_{k = 1}^{K} {p}_{k}^{+} + {p}_{k}^{-} \leq {ρ}_{1} {θ}_{1} + {ρ}_{∞} {θ}_{∞} , ∀ k & ( 5 g ) \\ {p}_{k}^{+} + {p}_{k}^{-} \leq {ρ}_{1} {θ}_{1} + {ρ}_{∞} {θ}_{∞} , ∀ k & ( 5 h )\end{matrix}$$
based thereon, transforming the model (5b) into a mixed linear programming problem to be solved, and passing an optimal {pₖ*} to an upper master problem for iterative calculation, wherein pₖ* represents the optimal probability value of the scenario k.

4. The data-driven three-stage scheduling method for electricity, heat and gas networks based on wind electricity indeterminacy according to claim 1, wherein in step S6, the gas network operation constraint subproblem is processed specifically as follows:
an objective function of the subproblem is:
$${max}_{{\overline{P}}_{i , t}^{gas} ∈ {G}_{gt} , t ∈ T} min {\sum }_{t = 1}^{T} {\sum }_{g ∈ {G}_{gt}} {λ}_{g} {N}_{g , t} \qquad ( 6 a )$$
wherein λ_{g} represents a gas network load-shedding penalty coefficient, G_{gt} represents a parameter set related to the gas network at the time t, N_{g,t} represents a load-shedding amount of the gas network during the period t, P̅_{i,t}^{gas} represents indeterminate power of the gas unit at a node i at the time t, and T represents the total number of periods;
when an objective function value of the subproblem is greater than 0, a constraint being a Benders cut set is added to a master problem by using a Benders algorithm; then it is returned to the master problem for resolving, wherein the Benders cut set generated by multiple iterations is always valid throughout the whole iteration process and must be all added to the constraint set of the master problem; and when the objective function value of the subproblem is 0, no new Benders cut set is generated, and the algorithm converges here to end the calculation.
